(19) United States
(12) Patent Application Publication
(10) Pub. No.: US 2024/0101016 A1
(43) Pub. Date: Mar. 28, 2024

(54) COMBINATION TABLE AND BED FIXTURE FOR RECREATIONAL VEHICLES

(71) Applicant: MORRYDE INTERNATIONAL, iNC., Elkhart, IN (US)

(72) Inventor: Ryan Mason, Niles, MI (US)

(21) Appl. No.: 18/371,304

(22) Filed: Sep. 21, 2023

Related U.S. Application Data
(60) Provisional application No. 63/409,547, filed on Sep. 23, 2022.

(51) Int. Cl. B60P 3/39

(52) U.S. Cl. CPC B60P 3/39

(57) ABSTRACT

A fixture for a recreational vehicle includes a bed arrangement with a main face of a first wall providing an upwardly facing bed surface and a table arrangement with a main face of a second wall providing an upwardly facing table surface.

### CROSS-REFERENCE TO RELATED APPLICATION

This application claims the priority benefit of U.S. Provisional Application No. 63/409,547, filed Sep. 23, 2023, which is hereby incorporated by reference in its entirety.

### FIELD OF THE DISCLOSURE

The present disclosure generally relates to fixtures for recreational vehicles and, more particularly, to table and bed fixtures for recreational vehicles.

### BACKGROUND

Usable space within recreational vehicles can be limited. As such, innovation is needed to maximize living spaces within the recreational vehicles while providing desired furniture and other fixtures.

### BRIEF DESCRIPTION OF THE DRAWINGS

FIG. 1 is a perspective view of a fixture for a recreational vehicle in accordance with the teachings of the present disclosure showing the fixture in a bed arrangement;

FIG. 2 is a perspective view of the fixture of FIG. 1 showing the fixture in a table arrangement;

FIG. 3 is a perspective view of the fixture of FIG. 1 showing the fixture in a stowed arrangement;

FIG. 4 is a side elevational view of the fixture of FIG. 1;

FIG. 5 is a sectional bottom perspective view of the fixture of FIG. 2 showing a catch holding the fixture in the table arrangement; and

FIG. 6 is a sectional bottom perspective view of a biased catch member for the catch of FIG. 5.

### SUMMARY

In accordance with one aspect, a fixture for a recreational vehicle is provided herein that includes a first wall configured to pivotably couple to an upright wall of the recreational vehicle on a proximal side thereof, and a second wall pivotably coupled to the first wall on a distal side thereof opposite to the upright wall. The fixture is configured to have a bed arrangement with the first wall extending outwardly from the upright wall and the second wall extending downwardly from the first wall to provide support therefor such that a main face of the first wall comprises an upwardly facing bed surface and a table arrangement with the first wall extending along the upright wall and the second wall extending outwardly from the upright wall such that a main face of the second wall comprises an upwardly facing table surface.

In some examples, the fixture can include a catch configured to hold the fixture in the table arrangement. In further examples, the catch can include a bracket configured to be mounted on the upright wall and a biased catch coupled to the first wall, the bracket and catch having interconnecting components configured to releasably engage one another.

In some examples, the fixture can include a ledge wall coupled to the first wall on the distal side thereof, where the ledge wall extends transverse with respect to the first wall, such that the ledge wall extends upwardly adjacent to the bed surface with the fixture in the bed arrangement. In further examples, an outer main face of the ledge wall can be generally co-planar with the main face of the second wall; the biased catch can be slidably coupled to the ledge wall, the ledge wall configured to engage the bracket to thereby engage the biased catch to the bracket; the ledge wall can be pivotably fixed relative to the first wall; the second wall can include an offset bracket to pivotably couple to the first wall spaced from a distal edge thereof, such that the second wall abuts the first wall in the table arrangement to be prevented from pivoting past perpendicular relative thereto; and/or the fixture can include a headboard coupled to an end of the first wall, such that the upright wall, ledge wall, and the headboard are configured to bound a bed reception area around the bed surface.

In some examples, the fixture can include a pair of corner supports extending between the first and second walls, the corner supports configured to support the first wall in the bed arrangement and the second wall in the table arrangement. In further examples, the corner supports can each further include a bumper configured to engage the first wall; and/or the corner supports can be pivotably coupled to the second wall to be movable from a use position extending between the first and second walls, to a storage position extending along the second wall. In yet further examples, the fixture can include a catch configured to selectively hold the corner supports in the use position.

Any of the above examples can further includes one or more of the following: the fixture can be configured to have a stowed arrangement with the first wall extending along the upright wall and the second wall extending along the first wall; the first wall can include an upright trim extending along a proximal edge thereof, such that the trim is configured to extend along the upright wall with the fixture in the bed arrangement; the fixture can include a support configured to be mounted to the upright wall, the first wall being pivotably coupled to the support; and/or the first wall can include an outer frame and a plurality of slats extending within the outer frame.

### DETAILED DESCRIPTION

Fixtures for recreational vehicles are provided herein that can advantageously be manipulated between bed and table arrangements. In some implementations, the fixtures can further have a stowed arrangement so that components of the fixture can be laid flat against a wall when not in use. The fixtures are suitable for any passenger or storage space within recreational vehicles. “Recreational vehicles” or “RVs” as described herein are intended to include toy haulers, travel trailers, fifth wheels, goosenecks, motor homes, campers, and so forth. The RV can be a towable trailer or a motorized unit.

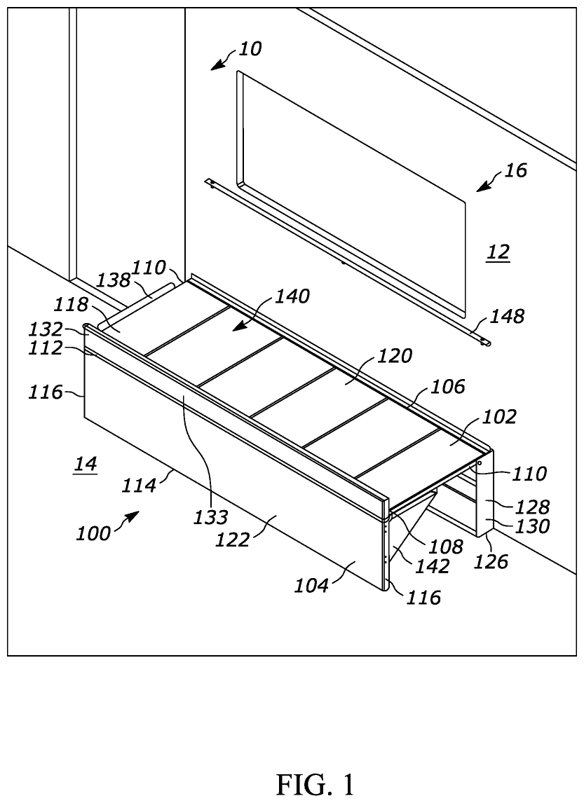

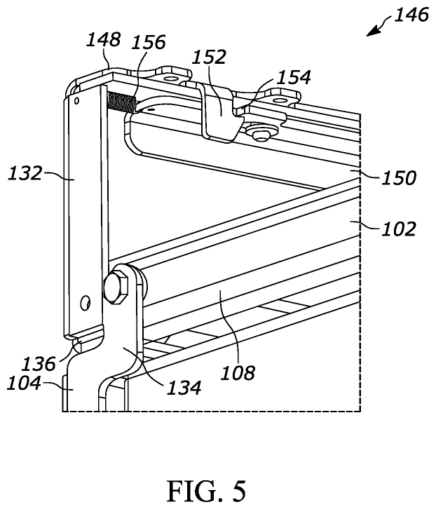

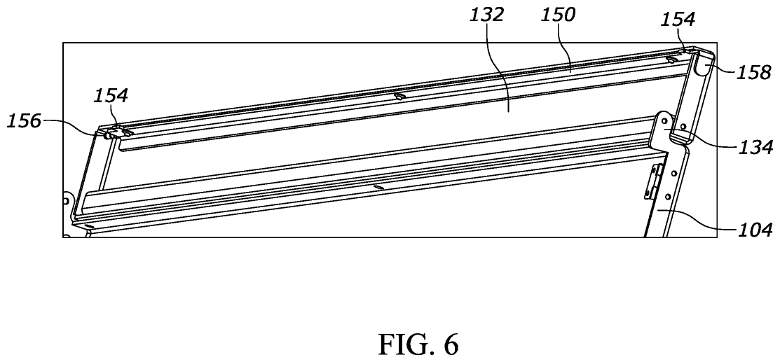

An example fixture 100 is shown in FIGS. 1-6. The fixture 100 is configured to be installed within a RV 10. As shown, the RV 10 includes a plurality of upright walls 12 and a floor 14 defining an interior space 16. The fixture 100 includes a first wall 102 configured to pivotably couple to one of the upright walls 12 of the RV 10 and a second wall 104 pivotably coupled to the first wall 102 on an opposite side thereof from the RV upright wall 12.

For example, the first wall 102 includes a proximal side 106 adjacent and pivotably coupled to the RV upright wall 12 and an opposite, distal side 108. Opposing ends 110 extend between the proximal and distal sides 106, 108. Similarly, the second wall 104 includes a proximal side 112 adjacent and pivotably coupled to the first wall 102 and an opposite, distal side 114. Opposing ends 116 extend between the proximal and distal sides 112, 114. The first and second walls 102, 104 can have any desired configuration. For example, the first wall and/or second wall can be a solid component of wood, metal, plastic, or combinations thereof. In another example, the first wall and/or second wall can have an outer frame and one or more interior members or slates extending within the frame.

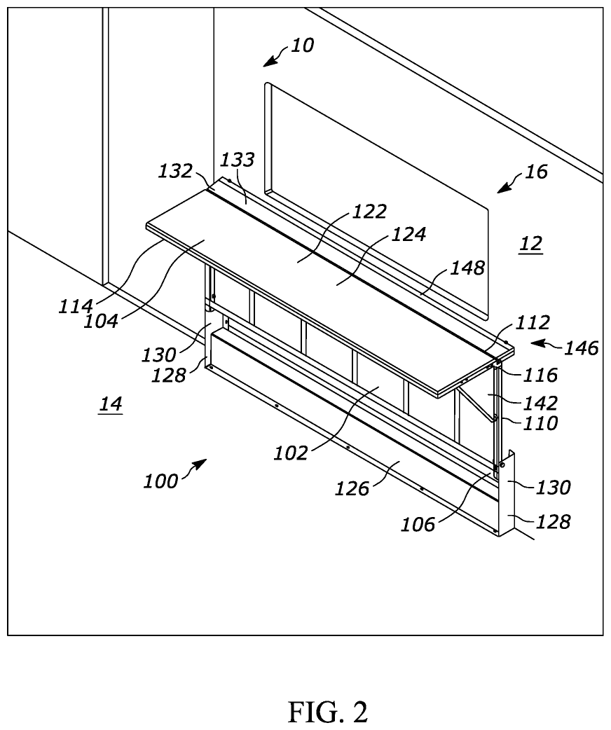

As shown in FIGS. 1 and 2, the fixture is configured to be manipulated between a bed arrangement (FIG. 1) and a table arrangement (FIG. 2). In the bed arrangement, the first wall 102 extends outwardly from the RV upright wall 12 and the second wall 104 extends downwardly from the first wall 102 to engage the RV floor 14 and provide support therefor. In this arrangement, a main face 118 of the first wall 102 can be an upwardly facing bed surface 120. It will be understood that the surface could also or alternatively be utilized as a table. In the table arrangement, the first wall 102 extends along the RV upright wall 12 and the second wall 104 extends outwardly from the RV upright wall 12 such that a main face 122 of the second wall 104 can be an upwardly facing table surface 124.

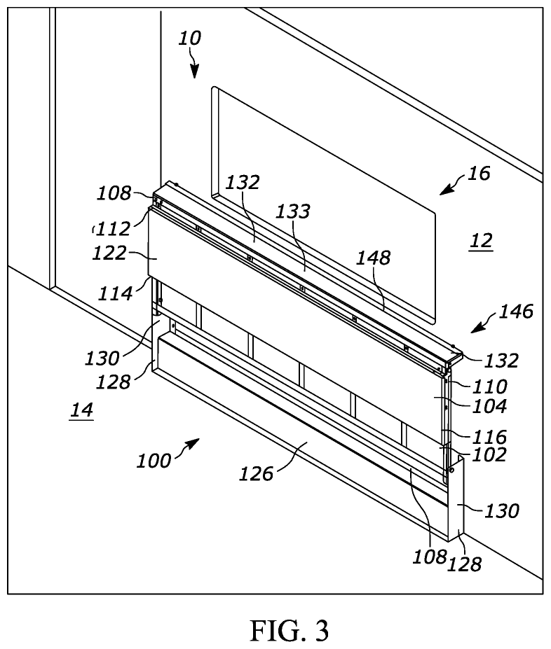

As shown in FIG. 3, in some implementations the fixture 100 can further be manipulated to a stowed arrangement with the first wall 102 extending along the RV upright wall 12 and the second wall 104 extending along the first wall 102. As user herein, “extending along” is intended to mean disposed adjacent to and generally parallel with. Accordingly, in the stowed arrangement, the first and second walls 102, 104 are disposed in generally vertical orientations to be generally parallel with the RV upright wall 12.

To couple the first wall 102 to the RV 10, the fixture 100 can include a support 126 mounted to the RV upright wall 12 and/or floor 14. The support 126 includes a pair of brackets 128 having opposing walls 130 that extend outwardly from the RV upright wall 12. As shown in FIGS. 1-3, the first wall 102 pivotably mounts to, such as by bolts, pins, or the like, and extends between the walls 130 of the brackets 128. The brackets 128 can be separate components or part of a unitary support structure.

In some implementations, the fixture 100 can further include a ledge wall 132 that is coupled to the first wall 102 on the distal side 108. As shown, the ledge wall 132 extends transversely with respect to the first wall 102, such that the ledge wall 132 extends upwardly adjacent to the bed surface 120 with the fixture 100 in the bed arrangement. If desired, the ledge wall 132 can be pivotably fixed relative to the first wall 102.

As shown, the ledge wall 132 is disposed adjacent to the second wall 104 at the distal side 108 of the first wall 102. For example, in the bed and table arrangements, an outer main face 133 of the ledge wall 132 can be generally co-planar with the main face 122 of the second wall 104. This is particularly advantageous in the table arrangement, as the ledge wall 132 provides additional table surface area.

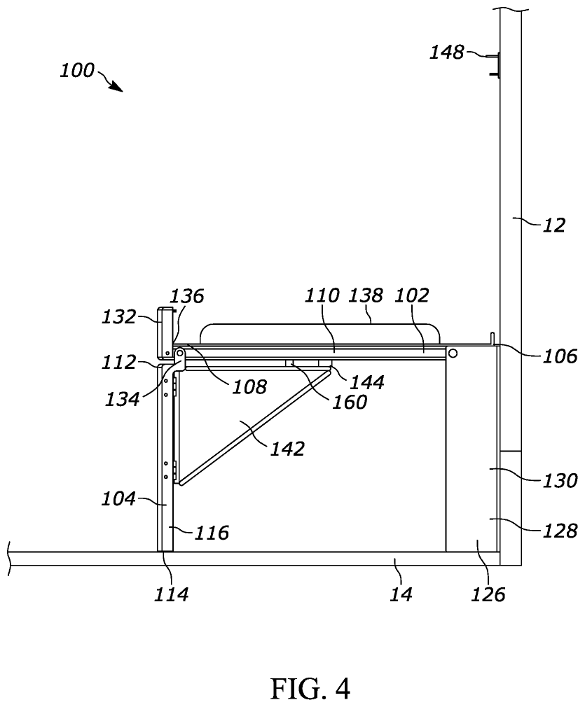

As shown in FIG. 4, the proximal side 112 of the second wall 104 can include offset brackets 134 that allow the second wall 104 to pivotably couple to the first wall 102 spaced from a distal edge 136 thereof. This configuration also allows the ledge wall 132 to be mounted to the distal edge 136, with the offset bracket 134 extending next thereto, so that the ledge wall 132 and the second wall 104 can be aligned, as discussed above. Further, the second wall 104 can be disposed underneath the first wall 102 in the bed arrangement with the pivot coupling through the offset bracket 134 making a proximal edge of the second wall 104 abut the bottom surface of the first wall 102. This configuration prevents the second wall 104 from pivoting past perpendicular relative to the first wall 102 to provide solid support for the bed arrangement.

In some implementations, the fixture 100 can further include a headboard 138 coupled to one of the ends 110 of the first wall 102. With this configuration, the RV upright wall 12, the ledge wall 132, and the headboard 138 are configured to bound a bed reception area 140 around the bed surface 120. Accordingly, a mattress or other bed material can be placed within the bed reception area 140 and the walls/headboard 12, 132, 138 will keep the mattress in place. In the illustrated form, the first wall 102 can also include an upright trim 141 that extends along a proximal edge thereof. With this configuration, the trim 141 extends along the RV upright wall 12 with the fixture 100 in the bed arrangement. The trim 141 can also be utilized to partially define the bed reception area 140.

As shown in FIGS. 1, 2, and 4, the fixture 100 can further include a pair of corner supports 142 that extend between the first and second walls 102, 104. The corner supports 142 are configured to support the first wall 102 in the bed arrangement and the second wall 104 in the table arrangement. For example, the corner supports 142 include a first edge that extends along the first wall 102 and a second edge that extends along the second wall. The corner supports 142 can have a triangular configuration, as shown. In some implementations, the corner supports 142 can include a bumper 144 that is configured to engage the first wall 102. The bumper 144 can be any suitable material, such as rubber, a polymer, and so forth. The corner supports 142 can be connected to the first wall 102 and/or the second wall 104.

In forms having the stowed arrangement, the corner supports 142 can be pivotably coupled to the second wall 104 and not connected to the first wall 102, such that the corner supports 142 are movable from a use position extending between the first and second walls 102, 104, to a storage position extending along the second wall 104. Advantageously, the second wall 104 can be configured to have a cavity or recess along an interior thereof, such that the corner supports 142 can pivot to be within the cavity of the second wall 104 in the storage position, and not impart additional width to the fixture 100 in the stowed arrangement.

In some cases, it can be helpful to secure the fixture in one or more of the arrangements. As such, the fixture 100 can include one or more catches to be held in the bed, table, and/or stowed arrangements. The catches can have any suitable form, including spring-biased catches, aligned openings to receive a pin/lock therein, removable fasteners, snap-lock connectors, hook and loop components, magnetic components, and so forth.

In one option, the fixture 100 can include table catch 146 to hold the fixture 100 in the table arrangement shown in FIG. 2. In the illustrated form, the table catch 146 includes a bracket 148 configured to be mounted on the RV upright wall 12. The table catch 146 can further include a biased catch member 150 that is coupled to the first wall 102. The bracket 148 and catch member 150 have interconnecting components that are configured to releasably engage one another. The components can be a hook 152 and ledge/edge 154 as shown. Other suitable configurations can be utilized, such as an opening, recess, or the like. The catch member 150 can be slidable relative to the bracket 148 and biased to a storage position by a spring or other biasing member 156, e.g., elastomer, polymer, etc., such that when the catch member 150 engages the bracket 148, the catch member 150 can be deflected from the storage position to allow the interconnecting components to engage one another. Thereafter, the spring 156 causes the catch member 150 to return to the storage position, locking the components together. When release is desired, a user can grasp the catch member 150, such as by an optional handle 158, to slide the catch member 150 against the biasing force to disengage the components, which allows the first wall 102 to pivot downwardly. The catch member 150 can be slidingly coupled to the first wall 102 or, as shown, slidingly coupled to the ledge wall 132. For example, the catch member 150 can be an elongate strip having slot openings with fasteners extending therethrough which allow the catch member 150 to slide relative to connecting structure. With this configuration, the ledge wall 132 engages the bracket 148 as the first wall 102 is pivoted to extend along the RV upright wall 12 to thereby engage the table catch 146 to hold the fixture 100 in the table arrangement.

In another option, the fixture 100 can include one or two catches 160 configured to selectively hold the corner supports 142 in the use position. The catch 160 can releasably couple the corner support 142 to the first wall 102.

The foregoing description is provided to enable a person skilled in the art to practice the various configurations described herein. While the subject technology has been particularly described with reference to the various figures and configurations, it should be understood that these are for illustration purposes only and should not be taken as limiting the scope of the subject technology.

The terms “substantially,” “approximately,” and “about” used throughout this Specification are used to describe and account for small fluctuations, such as due to variations in processing. For example, they can refer to less than or equal to ±5%, such as less than or equal to ±2%, such as less than or equal to ±1%, such as less than or equal to ±0.5%, such as less than or equal to ±0.2%, such as less than or equal to ±0.1%, such as less than or equal to ±0.05%.

It should be appreciated that all combinations of the foregoing concepts and additional concepts discussed in greater detail below (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein

It will be appreciated that elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments. The same reference numbers may be used to describe like or similar parts. Further, while several examples have been disclosed herein, any features from any examples may be combined with or replaced by other features from other examples. Moreover, while several examples have been disclosed herein, changes may be made to the disclosed examples within departing from the scope of the claims.

Those skilled in the art will recognize that a wide variety of modifications, alterations, and combinations can be made with respect to the above described embodiments without departing from the scope of the invention, and that such modifications, alterations, and combinations are to be viewed as being within the ambit of the inventive concept.

1. A fixture for a recreational vehicle, the fixture comprising:
a first wall configured to pivotably couple to an upright wall of the recreational vehicle on a proximal side thereof;
a second wall pivotably coupled to the first wall on a distal side thereof opposite to the upright wall;
wherein the fixture is configured to have:
a bed arrangement with the first wall extending outwardly from the upright wall and the second wall extending downwardly from the first wall to provide support therefor such that a main face of the first wall comprises an upwardly facing bed surface; and
a table arrangement with the first wall extending along the upright wall and the second wall extending outwardly from the upright wall such that a main face of the second wall comprises an upwardly facing table surface.

2. The fixture of claim 1, wherein the fixture is further configured to have a stowed arrangement with the first wall extending along the upright wall and the second wall extending along the first wall.

3. The fixture of claim 1, wherein the first wall comprises an upright trim extending along a proximal edge thereof, such that the trim is configured to extend along the upright wall with the fixture in the bed arrangement.

4. The fixture of claim 1, further comprising a catch configured to hold the fixture in the table arrangement.

5. The fixture of claim 4, wherein the catch comprises:
a bracket configured to be mounted on the upright wall; and
a biased catch coupled to the first wall, the bracket and catch having interconnecting components configured to releasably engage one another.

6. The fixture of claim 1, further comprising a ledge wall coupled to the first wall on the distal side thereof, the ledge wall extending transverse with respect to the first wall, such that the ledge wall extends upwardly adjacent to the bed surface with the fixture in the bed arrangement.

7. The fixture of claim 6, wherein an outer main face of the ledge wall is generally co-planar with the main face of the second wall.

8. The fixture of claim 6, wherein the biased catch is slidably coupled to the ledge wall, the ledge wall configured to engage the bracket to thereby engage the biased catch to the bracket.

9. The fixture of claim 6, wherein the ledge wall is pivotably fixed relative to the first wall.

10. The fixture of claim 6, wherein the second wall comprises an offset bracket to pivotably couple to the first wall spaced from a distal edge thereof, such that the second wall abuts the first wall in the table arrangement to be prevented from pivoting past perpendicular relative thereto.

11. The fixture of claim 6, further comprising a headboard coupled to an end of the first wall, such that the upright wall, ledge wall, and the headboard are configured to bound a bed reception area around the bed surface.

12. The fixture of claim 1, further comprising a support configured to be mounted to the upright wall, the first wall being pivotably coupled to the support.

13. The fixture of claim 1, further comprising a pair of corner supports extending between the first and second walls, the corner supports configured to support the first wall in the bed arrangement and the second wall in the table arrangement.

14. The fixture of claim 13, wherein the corner supports each further comprise a bumper configured to engage the first wall.

15. The fixture of claim 13, wherein the corner supports are pivotably coupled to the second wall to be movable from a use position extending between the first and second walls, to a storage position extending along the second wall.

16. The fixture of claim 15, further comprising a catch configured to selectively hold the corner supports in the use position.

17. The fixture of claim 1, wherein the first wall comprises an outer frame and a plurality of slats extending within the outer frame.
